(19) United States
(12) Patent Application Publication
(10) Pub. No.: US 2017/0112123 A1
(43) Pub. Date: Apr. 27, 2017

(54) USE OF ANTI-FOAMING AGENTS AS ANTI-DRIFT ADDITIVES

(71) Applicants: Michael KLOSTERMANN, Essen (DE); Joachim VENZMER, Essen (DE)

(72) Inventors: Michael KLOSTERMANN, Essen (DE); Joachim VENZMER, Essen (DE)

(73) Assignee: Evonik Degussa GmbH, Essen (DE)

(21) Appl. No.: 15/318,227

(22) PCT Filed: May 20, 2015
(86) PCT No.: PCT/EP2015/061055

§ 371 Date: Dec. 12, 2016

(30) Foreign Application Priority Data
Jun. 20, 2014 (DE) 10 2014 211 826.3

(51) Int. Cl. A01N 25/02; A01N 25/04; A01N 25/30

(52) U.S. Cl. CPC A01N 25/02; A01N 25/30; A01N 25/04

(57) ABSTRACT

The invention is directed to the use of defoamers as anti-drift additive.

### FIELD OF THE INVENTION

The invention is directed to the use of defoamers as anti-drift additive.

### PRIOR ART

One of the greatest unsolved problems in the farming of agricultural areas is the exact deposition of crop protection compositions. In customary atomization methods, droplets with a very broad droplet size distribution are usually generated. In this connection, it is known that the ability of the droplets to drift, i.e. uncontrolled transportation as a result of gentle air flows, correlates with the size of the droplets and is significantly more marked in the case of smaller droplets. In a series of field experiments, wind tunnel experiments and mathematical modelling, it was able to be shown in this connection that in particular droplet sizes of less than 150 μm have an increased susceptibility towards drift and therefore have an increased tendency towards so-called “off-target” deposition, which in turn leads to a high environmental impact for the surrounding area as well as to economic losses.

In order to overcome this problem, a series of additives for drift control has been developed in the past. In many cases here, the crop protection formulation is admixed with high molecular weight, water-soluble polymers as tank-mix additive which increase the viscosity of the spray and thus lead to the formation of larger droplets during spraying (see for example US 2001/0051145A1, US 2002/0108415 and WO 2008/101818 (US 2010/0152048)). However, one disadvantage of this approach is that often an only inadequate distribution of the spray on the plants can usually be achieved through the increased viscosity of the crop protection formulation. Moreover, corresponding polymers often only dissolve slowly during the tank mix operation. Inadequately dissolved polymer residues here can lead inter alia to a blockage of the spray nozzles, which then leads to problems such as pressure increase and defective distribution during the spraying operation.

Besides the use of high molecular weight polymers, the literature describes a series of further additives for drift control. For example, US 2012/0065068 describes the use of selected tertiary amines and amine oxides as anti-drift agents. US 2010/0113275 describes a series of self-emulsifying esters as anti-drift additives, whereas U.S. Pat. No. 6,797,673 B1 reports on the use of lecithins for drift control.

Further customary additives which are often used in agrochemical formulations are defoamers. These are intended to prevent the undesired formation of foam, e.g. during the tank mix operation when preparing spray liquors (see e.g. U.S. Pat. No. 5,504,054 A). Customary defoamers used in the agricultural sector are often based here on polyether-modified polydimethylsiloxanes. Moreover, silicone-free defoamers, which comprise for example vegetable oils as defoamer active ingredient, are also used in agriculture applications. However, the anti-drift effect of defoamers during the atomization of crop protection formulation has hitherto not been reported.

An object of the present invention was the provision of anti-drift additives.

### DESCRIPTION OF THE INVENTION

Surprisingly, it has been found that classic defoamers have anti-drift properties.

The subject matter of the present invention is therefore the use of defoamers as anti-drift additives, as described in the claims.

In the context of the invention, drift is understood as meaning the transversal locomotion of a spray from its place of origin. Drift is preferably caused by environmental influences and/or surrounding influences. These environmental and/or surrounding influences are preferably wind. This wind can be of natural or artificial origin. Wind of artificial origin is preferably air flows which are produced as a result of the locomotion of any vehicle on the land or in the air. Preferably, these are vehicles and/or aircraft used in the case of working an agricultural area.

The medium of the spray here is in all cases an aqueous medium. Preferably, the spray is formed by atomization in the air.

Drift is particularly preferably understood as meaning the transversal locomotion of a spray from the site of origin by wind, where the spray has formed as a result of atomization of an aqueous medium in the air.

For the purposes of working agricultural areas, suitable crop protection formulations of dilute aqueous formulations, so-called spray liquors, which can also contain further additives besides the crop protection agent, are used over a field.

In this connection, atomization means the droplet formation as a result of mechanical action on a liquid medium, preferably by rotation of objects and/or as a result of decompression (reduction in pressure) at small openings, particularly preferably with the help of nozzle-generated spray.

For the working of agricultural areas, 100-1000 l of spray liquor are generally sprayed per hectare. In exceptional cases, however, these limits can vary greatly upwards or downwards. In so-called low-volume applications, thus e.g. very small volumes down to 1.5 l/ha are sprayed, whereas in the case of application with so-called lance technology very high volumes up to 15 000 l/ha can be achieved. The atomization process here can take place either from high altitudes, for example by means of the spraying of spray liquors from an aeroplane, or from altitudes close to the earth, for example by spraying spray liquors by means of a tractor-mounted sprayer. Other equipment, such as spraying lances, or back-spraying are also known for applying spray liquors.

The effectiveness of an anti-drift additive can preferably be quantified by the influence of the additive on the droplet size distribution of the spray. There is a direct connection between the size of a droplet and its drift tendency—the finer the droplet, the greater the drift risk.

In the context of the present invention, the term droplet size distribution refers to volume-weighted size distributions upon measuring the diameters of the droplets in the spray mist. Preferably, volume-weighted droplet size distributions can be determined with the help of laser diffraction measurements (e.g. by using laser diffraction systems from Sympatec or Malvern according to ASTM Method E2798 and, referred to therein, E1260) or by means of computer-aided image analysis of highly resolved, statistical recordings of the spray mist.

More preferably, the droplet size is ascertained by means of image analysis of highly resolved recordings of the spray. Such recordings of the spray are preferably generated with the help of a high resolution high-speed camera, preference being given in particular to a camera of the type Vision Research Phantom V12. For this, the camera is positioned perpendicular to the spray lamellae 12 cm below the nozzle exit (flat spray nozzle of the type XR 11003 from TeeJet), and the spray is recorded at a magnification of 1.15 for a minimum of 20 seconds. The droplet size is then ascertained by means of image analysis of at least 2000 independent statistical individual images of the spray, as is described in the examples. Such determinations of the droplet size are likewise used to determine the volumes of the droplets.

The graphical plot of the volume percentage against the droplet diameter gives a typical particle distribution curve. Such distributions are shown in the figures of this invention. It is therefore possible to determine typical parameters of the distribution such as e.g. the volume fraction of the droplets which are smaller than a certain threshold value, and also the maximum of the distribution and the mean volumetric diameter (MVD). The mean volumetric diameter here is a measurement used to classify sprays and is defined in that of the atomized total volume of a liquid 50% of the drops are larger than this value and 50% are smaller than this value. Consequently, the MVD represents a volume-related median value.

The droplet size distribution of a spray is dependent on the composition of the spray and also on the conditions during the spraying operation. Thus, for example, the type of construction of the spray nozzle used and also the selected spraying pressure have a significant influence on the resulting droplet size distribution.

Preferably, the spray is generated using nozzles, preferably nozzles of the construction types flat spray nozzles, wide-angle flat-spray nozzles, double flat-spray nozzles, hollow cone nozzles, filled cone nozzles, high-pressure nozzles, edge nozzles, as well as air injector nozzles, more preferably nozzles of the construction type of a flat-spray nozzle. Nozzles of this type are available e.g. from the manufacturers Lechler, TeeJet and/or Agrotop. Particular preference is given to flat-spray nozzles from TeeJet, with the nozzles of the type XR 11003 being very particularly preferred.

Furthermore, preference is given to using a pressure of from 0.5 to 10 bar, preferably from 0.8 to 8 bar, more preferably from 0.9 to 6 bar, furthermore preferably from 0.95 to 2.5 bar and particularly preferably from 1 to 1.5 bar for generating spray.

The influence of the anti-drift additives on the droplet size distribution of a spray is always relative based on a spray of a formulation which is characterized by the absence of these additives for an otherwise identical composition and is sprayed under identical conditions.

The addition of the anti-drift additives according to the use preferably brings about a decrease in the volume fraction of droplets with a droplet diameter of less than 150 μm of min. 10%, preferably 15%, particularly preferably 20%, based on the droplet diameter of an identical spray without the addition of the anti-drift additive.

Furthermore, the addition of the anti-drift additives according to the use brings about a relative shift in the maximum of the droplet size distribution of min. 5%, preferably 10%, particularly preferably 15%, based on the droplet size distribution of an identical spray without the addition of an anti-drift additive.

Furthermore, the addition of the anti-drift additives according to the use brings about a relative increase in the volume-related median of the droplet size distribution of min. 5%, preferably 10%, particularly preferably 15%, based on the droplet size distribution of an identical spray without the addition of the anti-drift additive.

Furthermore, more preference is given to the use of defoamers as anti-drift additives, where the volume-related median of the droplet size distribution is at least 5% greater than that of a demin, water-based spray, where the spray is produced using a flat-spray nozzle of the type XR 11003 from TeeJet at a pressure of 1 bar and a temperature of 25° C., and the volume-related median is determined by image analysis of high resolution recordings of the spray.

One advantage of the use according to the invention of defoamers as anti-drift additives is that, besides their defoaming effect in spray liquors during the spraying operation, they lead to a reduction in small and thus driftable droplets, these are preferably droplets with a diameter of less than or equal to 150 μm, and a reduced “off-target” deposition occurs.

In the case of an agricultural application, the addition of the anti-drift additives according to the invention upon spraying active ingredients advantageously brings about a reduction in the contamination of the environment.

A further advantage is the avoidance of losses of expensive active ingredients since these are applied using the anti-drift compositions according to the invention to a higher percentage to the target area, e.g. in the case of agricultural use to the agricultural acreage.

In a preferred embodiment of the present invention, the defoamer here can be combined in the form of a surfactant-stabilized aqueous emulsion of a suitable defoamer active ingredient or in the form of a self-emulsifying defoamer active ingredient composition of the spray liquor.

A further advantage of the use according to the invention of defoamers as anti-drift additives is thus that the defoamers are able to be incorporated without problem into spray liquors with gentle stirring as a result of their presentation form. This facilitates firstly the preparation of spray liquors. Furthermore, it does not result in blockage of the spray nozzles as a result of the good incorporability and the associated homogeneous distribution during the spraying operation.

In a likewise preferred embodiment of the present invention, the defoamer can be combined in the form of a premix consisting of a self-emulsifying defoamer active ingredient and a further adjuvant of the spray liquor. Such mixtures have the advantage that they combine the positive anti-drift properties of the defoamer with the effectiveness boost of the adjuvant.

In a preferred embodiment of the use according to the invention, defoamers can be incorporated into the spray liquor directly during the tank mix operation. This spontaneously results in an adequately homogeneous distribution in the formulation.

The subject-matter of the invention is described hereinafter by way of example, without any intention of limiting the invention to these illustrative embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. When documents are cited in the context of the present description, the contents thereof, particularly with regard to the subject-matter that forms the context in which the document has been cited, are considered in their entirety to form part of the disclosure-content of the present invention. Unless stated otherwise, percentages are figures in per cent by weight. When mean values are reported hereinafter, the values in question are weight averages, unless stated otherwise. When parameters which have been determined by measurement are reported hereinafter, they have been determined at a temperature of 25° C. and a pressure of 101 325 Pa, unless stated otherwise.

The statement of a mass ratio of e.g. component (a) to component (b) of 0.1 means that a mixture comprising these two components has 10% by weight of component (a), based on the mass sum of components (a) and (b).

The term adjuvant describes substances or auxiliaries which enhance the effect of a crop protection agent.

The term defoamer describes surface-active chemical substances and formulations which suppress or at least reduce foam formation. Foam formation can arise upon preparing spray liquors.

The defoamers are preferably investigated in accordance with the CIPAC method MT 47. Here, a defoamer-free formulation is compared with a defoamer-containing formulation. The defoamer must reduce the foam.

Foam reduction can be the reduction in the absolute amount of foam, as well as the reduction in the foam disintegration time. Preferably, the foam reduction is a reduction in the absolute amount of foam.

In the context of the present invention, preference is given in particular to those defoamers which comprise at least one polyether siloxane of the formula (I).

Mₐ D_{b} T_{c} Q_{d} formula (I)

M=[R^{f}₃SiO_{1/2}]

D=[R^{f}₂SiO_{2/2}],

T=[R^{f}SiO_{3/2}]

Q=[SiO_{4/2}]

where

a=2-22, preferably 2-14, in particular 2,

b=3-500, preferably 10-300, in particular 30-250,

c=0-16, preferably 0-8, in particular 0,

d=0-10, preferably 0-6, in particular 0,

where the radical R^{f} is a radical R¹, R² or R³, with the proviso that at least one radical R^{f} is a radical R², where

R¹ is an alkyl radical having 1 to 16, preferably 1-4 carbon atoms or the aryl radical,

R² is a polyether radical of the formula (II)

—(Y)ₑ[O(C₂H_{4-f}R⁴_{f}O)ₘ(CₓH₂ₓO)ₚZ]_{w} formula (II)

where

e=0 or 1, preferably 1,

f=1 to 3, preferably 1,

m≧1 to 50, preferably 2 to 40, more preferably 3 to 30, particularly preferably 5 to 200,

x=2 to 4,

p≧0 up to 20, preferably 0-15,

w=1 to 4, preferably 1,

sum of m+p=3 to 150, preferably 3-10

R⁴=independently of the others, a hydrogen radical, a monovalent aliphatic hydrocarbon radical having 1 to 18 carbon atoms, or an aromatic hydrocarbon radical having 6-18 carbon atoms, which can optionally also be a substituted aromatic whose substituents are selected from the groups hydrogen radical, alkyl radical having 1 to 6 carbon atoms, alkoxy radical and hydroxy radical,

Z=independently of the others, a hydrogen radical or a monovalent organic radical, preferably hydrogen, methyl, butyl or —C(O)Me,

Y=a (w+1)-valent hydrocarbon radical having 1 to 18 carbon atoms, which can also be branched, preferably —(CH₂)₃—,

R³ is a polyether radical of the formula (III)

—(F)_{q}[O(C_{z}H_{2z}O)ᵣZ]_{g} formula (III)

where

g=1 to 4, preferably 1,

q=0 or 1, preferably 1,

z=2 to 4, preferably 2,

r≧3, preferably 3-20, particularly preferably 3-16,

F=a (g+1)-valent hydrocarbon radical having 1 to 18 carbon atoms, which can also be branched, preferably —(CH₂)₃—

Z is as defined for formula (II),

but at least 80% of the radicals R^{f} are methyl radicals.

The siloxane backbone of the polyethersiloxanes of the formula (I) can be straight-chain (c+d=0) or else branched (c+d>0). In the case of index e and/or index q being equal to 0, the siloxane backbone is preferably branched. In the case of indices e and q each being equal to 1, the siloxane backbone is preferably straight-chain.

The compounds according to the invention are liquid at room temperature. Consequently, not all of the combinations of the values are possible for a, b, c and d. Particularly if c and d are not 0, a must tendentially be greater than the sum (c+d).

The values of a, b, c and d are to be understood as being average values in the polymer molecule. The silicone polyether copolymers to be used according to the invention are preferably present in the form of equilibrated mixtures.

The radicals R¹ are alkyl radicals, having 1 to 4 carbon atoms, such as methyl, ethyl, n-propyl, n-butyl or aryl radicals, where the phenyl radicals are preferred among the aryl radicals. Methyl radicals are preferred, meaning that at least 80% of the radicals R¹ should be methyl radicals. Particular preference is given to those polyethersiloxanes of the formula (I) in which all of the radicals R¹ are methyl radicals.

When using polyethersiloxane-based defoamers as anti-drift additives, the polyethersiloxanes, in particular polyethersiloxanes of the formula (I), can be used individually or as mixtures. Preferably, corresponding mixtures comprise polyethersiloxanes, in particular those of the formula (I) which differ as regards their structure and/or their molecular weight.

Furthermore, as anti-drift additives, preference is also given to those defoamers which comprise silicone oils as defoamer active ingredient. The silicone oil here is preferably a polydimethylsiloxane.

Moreover, as anti-drift additives, preference is also given to those defoamers which comprise, as defoamer active ingredient, silicone-free compounds such as mineral oils, vegetable oils, monoglycerides of fatty acids, polyethylene waxes, stearin waxes, amide waxes or mixtures of these substances. Particular preference is given here to defoamers based on vegetable oils, particularly preferably rapeseed oil. Further customary names for rapeseed oil are colza oil and rape oil. These oils are characterized by a content of oleic acid of from 51 to 70% by weight, linoleic acid of from 15 to 30% by weight and linolinic acid from 5 to 14% by weight, where yet further fatty acids can be esterified with the glycerol. Reference may be made at this point to the Deutsche Gesellschaft für Fettwissenschaft (DGF) [German Society for Fat Science], “Fettsäurezusammensetzung wichtiger pflanzlicher und tierischer Speisefette und-öle” [Fatty Acid Composition of Important Vegetable and Animal Food Fats and Oils], http://www.dgfett.de/material/fszus.htm (20.05.2014).

Particular preference is given to a combination of defoamers as anti-drift additives comprising at least one polyethersiloxane of the formula (I) and at least one polydimethylsiloxane.

The defoamers according to the use are preferably used as anti-drift additives for spraying in aqueous crop protection formulations.

It may be advantageous if the defoamer additionally comprises finely divided solids. These may be either inorganic or organic solids. Preferred inorganic solids are hydrophobized silicas, aluminium oxide, alkaline earth metal carbonates and/or similar solids known from the prior art and customary finely divided solids. In particular here, hydrophobized or at least partially hydrophobized silicas, such as e.g. various Aerosil or Siperant types from Evonik Industries, are preferred. As organic solids, preference is given to alkaline earth metal salts of long-chain fatty acids having 12 to 22 carbon atoms, the amides of these fatty acids, and polyureas.

Preferably, the defoamer according to the use is surfactant-stabilized in an aqueous emulsion by at least one defoamer active ingredient. Emulsifiers which can be used here are one or more non-ionic or anionic emulsifiers.

Preferred non-ionic emulsifiers are the fatty acid esters of polyhydric alcohols, their polyalkylene glycol derivatives, the polyglycol derivatives of fatty acids and fatty alcohols, alkylphenol ethoxylates, and block copolymers of ethylene oxide and propylene oxide, ethoxylated amines, amine oxides, acetylenediol surfactants and silicone surfactants. More preferably, polyglycol derivatives of fatty acids and fatty alcohols are used. Particularly preferred polyglycol derivatives are ethoxylates of fatty acids and fatty alcohols. Particular preference is given to ethoxylates based on oleyl and stearyl acid or the same alcohols.

Preferred anionic emulsifiers are dialkyl sulphosuccinates, alkyl ether sulphates and phosphates, alkyl sulphates and alpha-olefinsulphonates. Special anionic block copolymeric emulsifiers, as described in DE 19836253 A, are also preferred.

Preferably, the defoamer active ingredient is self-emulsifying. In this connection, self-emulsifying means that the defoamer active ingredient can be dispersed in water without great shear input and hereby spontaneously forms emulsion droplets with an average diameter of less than 300 μm, preferably less than 200 μm, particularly preferably less than 100 μm. In this connection, it may optionally be advantageous if the defoamer active ingredient is mixed beforehand with further surface-active substances which enhance its self-emulsifying properties.

In the case of self-emulsifying defoamer active ingredients, it may moreover be advantageous to mix the defoamer active ingredient beforehand with at least one further adjuvant. Preferred adjuvants here are selected from the group of trisiloxane, n-alkyl glycosides, fatty alcohol ethoxylates, and nonylphenol ethoxylates. Particular preference is given here to trisiloxanes, such as e.g. BreakThru® S200,BreakThru® S233, BreakThru® S240 and BreakThru® S278 (trade names of Evonik Industries AG, Essen, Germany).

The crop protection agent here can be selected from the group of acaricides (AC), algicides (AL), attractants (AT), repellents (RE), bactericides (BA), fungicides (FU), herbicides (HE), insecticides (IN), agents to combat slugs and snails, molluscicides (MO), nematicides (NE), rodenticides (RO), sterilants (ST), viridicides (VI), growth regulators (PG), plant strengtheners (PS), micronutrients (MI), macronutrients (MA) or mixtures of these substances; such substances and their field of application are known to the person skilled in the art. Some of these active ingredients or active organisms are listed for example in “The Pesticide Manual”, 14th edition, 2006, The British Crop Protection Council, or in “The Manual of Biocontrol Agents”, 2004, The British Crop Protection Council. However, the present application is limited not only to these active ingredients listed therein.

Moreover, such crop protection formulations can also comprise further auxiliaries such as e.g. emulsifiers, thickeners, dispersion auxiliaries, antifrost agents, biocides and/or surface-active substances; such substances are known to the person skilled in the art.

### SHORT DESCRIPTION OF THE FIGURES

FIG. 1: Volume-weighted droplet size distribution of demin. water sprays.

FIG. 2: Volume-weighted droplet size distribution of a demin. water spray (triangles) and of a spray of water+0.1% of a self-emulsifying polyethersiloxane defoamer mixture (squares).

FIG. 3: Volume-weighted droplet size distribution of a demin. water spray (triangles) and of a spray of water +0.1% of a self-emulsifying plant oil defoamer (squares).

FIG. 4: Volume-weighted particle size distribution of a demin. water spray (triangles) and of a spray of water +0.1% of a 50:50 (w/w) mixture of BreakThru S200 and a self-emulsifying polyethersiloxane (diamonds).

### EXAMPLES

Substances:

Tegopren® 3158 is a polyethersiloxane, Tegopren® 3059 is a polyethersiloxane, Tego® Antifoam KS 53 is a vegetable oil-based defoamer and BreakThru® S200 is a trisiloxane surfactant (trade name of Evonik Industries AG, Essen, Germany).

Spraying Experiments:

All of the spraying experiments were carried out using a flat-spray nozzle of the type XR 11003 from TeeJet. All of the spraying experiments were carried out here at a spraying pressure of 1 bar. The particle size of the resulting spray was determined by means of the image analysis of highly resolved recordings of the spray. For this, a high-speed camera of the type Vision Research Phantom V12 was positioned perpendicularly to the spray lamellae 12 cm below the nozzle exit and the spray was filmed at a magnification of 1.15 for a minimum of 20 sec. The droplet size distribution was then determined by means of the image analysis of a minimum of 2000 independent, statistical individual images of the spray. For this, the individual drops were detected by reference to their intensity deviating from the background. The projected area of each drop was then determined from the recorded images, which was used to calculate an equivalent diameter: D=(4*A/pi)^{0.5}, where D is the equivalent diameter and A is the projected area. The result obtained was a volume-weighted droplet size distribution, by means of which the maximum distribution and also the mean volumetric diameter (MVD) can be determined. This image analysis was carried out here using the computer program Matlab (for details and background see e.g. R. C. Gonzalez, S. L. Eddins and R. E. Wood, “Digital Image Processing using Matlab”, 2004, Prentice Hall Verlag or see K. J. Hay, Z.-C.- Liu, T. J. Hanratty, “A Backlighted Imaging Technique for Particle Size Measurements in Two Phase Flows”, Experiments in Fluids, 1998, 25(3), 226-232).

Determination of the Particle Size of the Defoamer Emulsions

Determination of the particle size of the defoamer emulsion was carried out by laser diffraction measurements using the Malvern MasterSizers 3000. The measurements were carried out here in dilute aqueous solutions. The evaluation of the scattered signal was carried out automatically by the software supplied with the instrument. The result obtained was a volume-weighted particle size distribution. In order to ensure that the droplet size of the emulsion does not change as a result of the dilution, an estimation of the droplet size was additionally carried out by means of viewing micrographs of the undiluted emulsion.

### Comparative Example 1

### Spraying Experiment with Pure Water

Demin. water was atomized under the conditions described above. FIG. 1 shows the volume-weighted droplet size distribution ascertained with the help of image analysis. The maximum droplet size distribution is 260 μm. Moreover, an average volumetric diameter of 252 μm will be determined.

### Example 2 According to the Invention

### Spraying Experiment with Water+Silicone Defoamer

The silicone defoamer used was a self-emulsifying mixture of in each case 50 parts by weight of Tegopren 3158 and Tegopren 3059. 0.1 parts by weight of this mixture were incorporated with gentle stirring into 99.9 parts by weight of demin. water. The resulting emulsion of the defoamer active ingredient mixture had a particle size of less than 100 μm (ascertained by laser diffraction using a Malvern MasterSizer 3000). This water/defoamer mixture was atomized under the experimental conditions given above.

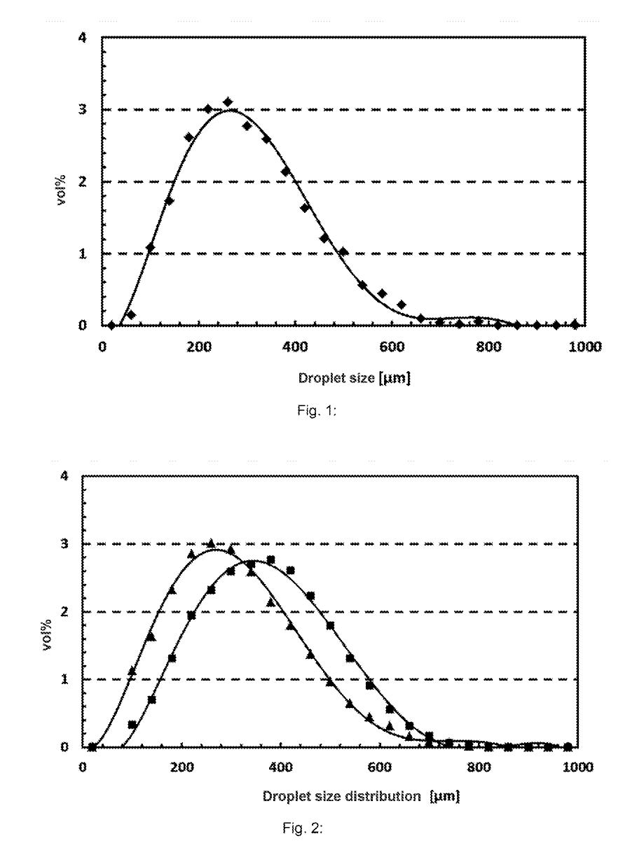

FIG. 2 shows the volume-weighted droplet size distribution ascertained with the help of image analysis.

The maximum droplet size distribution compared to pure water shifted from 260 μm to 355 μm. The MVD shifted from 252 μm for pure water to 367 μm as a result of the anti-drift additive.

### Example 3 According to the Invention

### Spraying Experiment with Water+Vegetable Oil-Based Defoamer

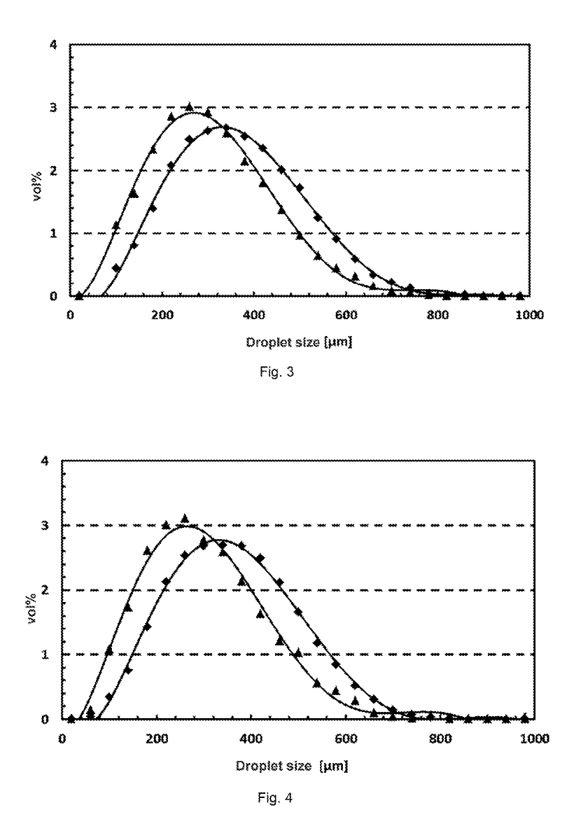

The defoamer used was the self-emulsifying defoamer active ingredient Tego Antifoam KS 53. 0.1 parts by weight of the defoamer were incorporated into 99.9 parts by weight of water with gentle stirring. The resulting emulsion of the defoamer active ingredient mixture had a particle size of less than 100 μm (ascertained by laser diffraction using a Malvern MasterSizer 3000). This water/defoamer mixture was atomized under the experimental conditions given above. FIG. 3 shows the volume-weighted droplet size distribution ascertained with the help of image analysis.

The maximum droplet size distribution compared to demin. water shifted from 260 μm to 340 μm. The MVD shifted from 252 μm for pure water to 355 μm as a result of the anti-drift additive.

### Example 4 According to the Invention

### Spraying Experiment with Water+Trisiloxane Adjuvant+Silicone Defoamer

The silicone defoamer used was a self-emulsifying mixture of in each case 50 parts by weight of Tegopren 3158 and Tegopren 3059. 50 parts by weight of this mixture were mixed with 50 parts by weight of the trisiloxane adjuvant BreakThru S200. 0.1 parts by weight of this adjuvant/defoamer mixture were dispersed in 99.9 parts by weight of water with gentle stirring. The resulting emulsion had a particle size of <100 μm (ascertained by laser diffraction using a Malvern MasterSizer 3000). Then, the aqueous emulsion was sprayed under the experimental conditions stated above. FIG. 4 shows the volume-weighted droplet size distribution ascertained with the help of image analysis.

The maximum droplet size distribution compared to demin. water shifted from 260 μm to 335 μm. The MVD shifted from 252 μm for pure water to 354 μm as a result of the anti-drift additive.

1. A method for reducing drift of a spray from its place of origin comprising incorporating at least one defoamer into said spray.

2. The method of claim 1, wherein the at least one defoamer is incorporated into a crop protection formulation spray.

3. The method of claim 2, wherein the defoamer comprises at least one polyethersiloxane of the formula (I);
Mₐ D_{b} T_{c} Q_{d}, formula (I)
wherein
M=[R^{f}₃SiO_{1/2}]
D=[R^{f}₂SiO_{2/2}]
T=[R^{f}SiO_{3/2}]
Q=[SiO_{4/2}]
wherein
a=2-22,
b=3-500,
c=0-16,
d=0-10,
where the radical R^{f} is a radical R¹, R² or R³, with the proviso that at least one radical R^{f} is a radical R², where
R¹ is an alkyl radical having 1 to 16, carbon atoms or the aryl radical,
R² is a polyether radical of the formula (II):
—(Y)e[O(C₂H_{4-f}R⁴_{f}O)ₘ(CₓH₂ₓO)ₚZ]_{w},
where
e=0 or 1,
f=1 to 3,
m≧1 to 50,
x=2 to 4,
p≧0 up to 20,
w=1 to 4,
sum of m+p=3 to 150,
R⁴=independently of the others, a hydrogen radical, a monovalent aliphatic hydrocarbon radical having 1 to 18 carbon atoms, or an aromatic hydrocarbon radical having 6-18 carbon atoms, which can optionally be a substituted aromatic whose substituents are selected from the group consisting of at least one hydrogen radical, alkyl radical having 1 to 6 carbon atoms, alkoxy radical and hydroxy radical,
Z=independently of the others, hydrogen, methyl, butyl, C(O)Me, or another hydrogen radical or a monovalent organic radical,
Y=a (w+1)-valent hydrocarbon radical having 1 to 18 carbon atoms, which can also be branched,
R³ is a polyether radical of the formula (III):
—(F)_{q}[O(C_{z}H_{2z}O)ᵣ Z]_{g},
wherein
g=1 to 4,
q=0 or 1,
z=2 to 4,
r≧3,
F=a (g+1)-valent hydrocarbon radical having 1 to 18 carbon atoms, which can be branched,
Z is as defined for formula (II),
with the proviso that at least 80% of the radicals R^{f} are methyl radicals.

4. The method according to claim 2, wherein the at least one defoamer comprises, as an active ingredient, at least one silicone-free component selected from the group consisting of water-insoluble triglycerides, vegetable oils, mineral oils, polyethylene waxes, stearin waxes, and amide waves, or mixtures of these substances.

5. The method according to claim 4, wherein the defoamer comprises rapeseed oil.

6. The method according to claim 1, wherein the at least one defoamer comprises consists of an aqueous surfactant-stabilized emulsion.

7. The method according to claim 1 5, wherein the at least one defoamer is self-emulsifying.

8. The method according to claim 7, wherein the self-emulsifying defoamer is mixed beforehand with at least one further adjuvant selected from the group consisting of trisiloxanes, n-alkyl glycosides, fatty alcohol ethoxylates, and nonylphenol ethoxylates, or mixtures thereof.

9. The method according to claim 8, wherein the at least one further adjuvant is a trisiloxane.

10. The method of claim 3, wherein in formula (I) a=2, b=30-250, c=0 and d=0, R1 is 1 to 4; in formula (II) e=1, f=1, m is 5 to 20, p=0 to 15, w=1, the sum of m+p is 3 to 10, Z=hydrogen, methyl, butyl or —C(O)Me, Y=(CH₂)₃; and in formula (III) g=1, q=1, z=2, and r is 3 to 16, and F is —(CH₂)₃—.

11. The method of claim 3, wherein said crop protection formulation spray exhibits less drift when applied at a place of origin than an otherwise identical crop protection formulation spray that does not incorporate said at least one defoamer of formula (I).

12. A crop protection formulation spray comprising at least one defoamer comprises at least one polyethersiloxane of the formula (I):
Mₐ D_{b} T_{c} Q_{d},
wherein
M=[R^{f}₃SiO_{1/2}]
D=[R^{f}₂SiO_{2/2}]
T=[R^{f}SiO_{3/2}]
Q=[SiO_{4/2}]
where
a=2-22,
b=3500,
c=0-16,
d=0-10,
where the radical R^{f} is a radical R¹, R² or R³, with the proviso that at least one radical R^{f} is a radical R², where
R¹ is an alkyl radical having 1 to 16, carbon atoms or the aryl radical,
R² is a polyether radical of the formula (II):
—(Y)ₑ[O(C₂H_{4-f}R⁴_{f}O)ₘ(CₓH₂ₓO)ₚZ]_{w},
where
e=0 or 1,
f=1 to 3,
m≧1 to 50,
x=2 to 4,
p≧0 up to 20,
w=1 to 4,
sum of m+p=3 to 150,
R⁴=independently of the others, a hydrogen radical, a monovalent aliphatic hydrocarbon radical having 1 to 18 carbon atoms, or an aromatic hydrocarbon radical having 6-18 carbon atoms, which can optionally be a substituted aromatic whose substituents are selected from the group consisting of at least one hydrogen radical, alkyl radical having 1 to 6 carbon atoms, alkoxy radical and hydroxy radical,
Z=independently of the others, hydrogen, methyl, butyl, C(O)Me, or another hydrogen radical or a monovalent organic radical,
Y=a (w+1)-valent hydrocarbon radical having 1 to 18 carbon atoms, which can also be branched,
R³ is a polyether radical of the formula (III):
—(F)_{q}[O(C₂H_{2z}O)ᵣZ]_{g},
wherein
g=1 to 4,
q=0 or 1,
z=2 to 4,
r≧3,
F=a (g+1)-valent hydrocarbon radical having 1 to 18 carbon atoms, which can be branched,
Z is as defined for formula (II),
with the proviso that at least 80% of the radicals R^{f} are methyl radicals;
wherein said crop protection formulation spray exhibits less drift when applied at a place of origin than an otherwise identical crop protection formulation spray that does not incorporate said at least one defoamer of formula (I).

13. The crop protection formulation spray of claim 12, wherein defoamer formula (I) a=2, b=30-250, c=0 and d=0, R1 is 1 to 4; in formula (II) e=1, f=1, m is 5 to 20, p=0 to 15, w=1, the sum of m+p is 3 to 10, Z=hydrogen, methyl, butyl or —C(O)Me, Y=(CH₂)₃; and in formula (III) g=1, q=1, z=2, and r is 3 to 16, and F is —(CH₂)₃—.

14. A method for reducing drift of a spray from its place of origin comprising incorporating at least one defoamer into said spray, wherein said at least one defoamer comprises at least one polyethersiloxane of the formula (I):
Mₐ D_{b} T_{c} Q_{d},
wherein
M=[R^{f}₃SiO_{1/2}]
D=[R^{f}₂SiO_{2/2}]
T=[R^{f}SiO_{3/2}]
Q=[SiO_{4/2}]
where
a=2-22,
b=3-500,
c=0-16,
d=0-10,
where the radical R^{f} is a radical R¹, R² or R³, with the proviso that at least one radical R^{f} is a radical R², where
R¹ is an alkyl radical having 1 to 16, carbon atoms or the aryl radical,
R² is a polyether radical of the formula (II):
—(Y)[O(C₂H_{4-f}R⁴_{f}O)ₘ(CₓH₂ₓO)ₚZ]_{w},
where
e=0 or 1,
f=1 to 3,
m≧1 to 50,
x=2 to 4,
p≧0 up to 20,
w=1 to 4,
sum of m+p=3 to 150,
R⁴=independently of the others, a hydrogen radical, a monovalent aliphatic hydrocarbon radical having 1 to 18 carbon atoms, or an aromatic hydrocarbon radical having 6-18 carbon atoms, which can optionally be a substituted aromatic whose substituents are selected from the group consisting of at least one hydrogen radical, alkyl radical having 1 to 6 carbon atoms, alkoxy radical and hydroxy radical,
Z=independently of the others, hydrogen, methyl, butyl, C(O)Me, or another hydrogen radical or a monovalent organic radical,
Y=a (w+1)-valent hydrocarbon radical having 1 to 18 carbon atoms, which can also be branched,
R³ is a polyether radical of the formula (III):
—(F)_{q}[O(C_{z}H_{2z}O)ᵣZ]_{g},
wherein
g=1 t 4,
q=0 or 1,
z=2 to 4,
r≧3,
F=a (g+1)-valent hydrocarbon radical having 1 to 18 carbon atoms, which can be branched,
Z is as defined for formula (II),
with the proviso that at least 80% of the radicals R^{f} are methyl radicals.
